(19) United States
(12) Patent Application Publication
(10) Pub. No.: US 2001/0025224 A1
(43) Pub. Date: Sep. 27, 2001

(54) Screensaver road map

(75) Inventors: Hans-Gunter Schneider, Monchengladbach (DE); Josef Heimann, Dusseldorf (DE)

Correspondence Address: Thomas C. Pontani, Esq., COHEN, PONTANI, LIEBERMAN & PAVANE, Suite 1210, 551 Fifth Avenue, New York, NY, 10176, US

(73) Assignee: Atecs Mannesmann AG

(21) Appl. No.: 09/785,639

(22) Filed: Feb. 16, 2001

(30) Foreign Application Priority Data
Feb. 17, 2000 (DE) 100 08 363

(51) Int. Cl. G01C 21/30

(52) U.S. Cl. 701/211; 340/991

(57) ABSTRACT

A method of providing information to a terminal of a user includes transmitting the information via a telecommunication network channel and displaying the information as a screensaver on a terminal display.

### BACKGROUND OF THE INVENTION

1. Field of the Invention

The invention relates to methods and devices for providing information on a terminal for the user of a terminal.

2. Description of the Related Art

A method for transmitting traffic information to a terminal to be displayed there is known, for example, from DE 197 06 046 A1.

### SUMMARY OF THE INVENTION

The object of the present invention is to provide a method which conveys information, especially traffic information, as efficiently and ergonomically as possible to a terminal to be visually displayed there.

The object is achieved by a method for providing information on a terminal for a user of the terminal, comprising the steps of transmitting the information to a terminal via a channel of a telecommunication network, and displaying the information as a screensaver on a display at the terminal.

According to the present invention, the transmission of information such as, for example, traffic information to be displayed on a display of the terminal as a screensaver allows a user of the terminal to follow the traffic information very efficiently from a conventional PC. The method according to the present invention allows a user to look at the traffic situation at the end of a working day before starting the journey home. If necessary, the user may select a suitable route for traveling home or to defer the trip home in the case of a traffic jam.

The traffic information is suitably conveyed to the terminal as a digital map (e.g. as a bitmap) by line network or by mobile radio, and is displayed at the terminal as a screensaver. At least one profile for each user of the terminal is preferably stored in a traffic information center which sends out the traffic information to the terminal. Accordingly, each user is sent a particular digital map with current traffic information (accidents, traffic jams, traveling times, etc.). The transmission may be cyclic or may be based on changes (especially those predetermined from the traffic information center by the user of the terminal). The digital map is preferably provided with hyperlink areas or mouse-over areas at certain positions such as, for example, at traffic jams which trigger the display of additional information on the screen by clicking on them or moving over them with a mouse on the screen.

A warning function is preferably implemented which triggers an audible note in response to a particular (especially predetermined) change in the traffic situation. The warning function may be arranged at the terminal or at the traffic center.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a diagrammatic view of the transmission of traffic information from a traffic center to a terminal; and

FIG. 2 is a front view of a terminal display showing an example of a digital map from information transmitted from the traffic center.

### DETAILED DESCRIPTION OF THE PRESENTLY PREFERRED EMBODIMENTS

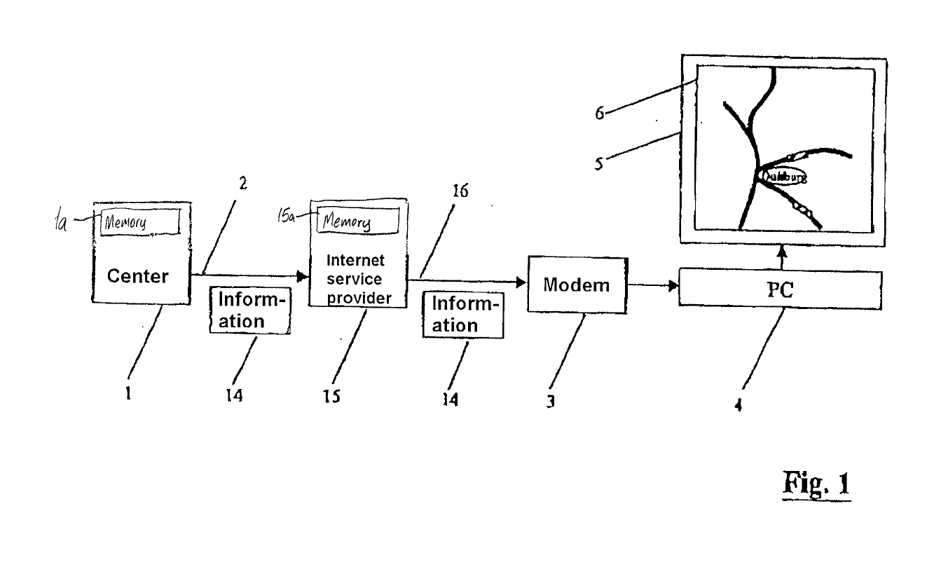

FIG. 1 shows the transmission of information 14 containing a digital map 6 from a center 1 to a modem 3 via a network 2, 16. The modem 3 is connected to a terminal 4 in the form of a PC with a screen 5. The digital map 6 is displayed as a screensaver on the screen 5 based on the transmitted information 14.

Of course, the information 14 does not have to contain a digital map. As an alternative, the information may also include events, points of interest, ticket offers, auctions, and locational information about a specific location. Accordingly, the center 1 does not have to be a traffic center. Rather, the center 1 may comprise a server for any type of information 14 for which users desire updated information.

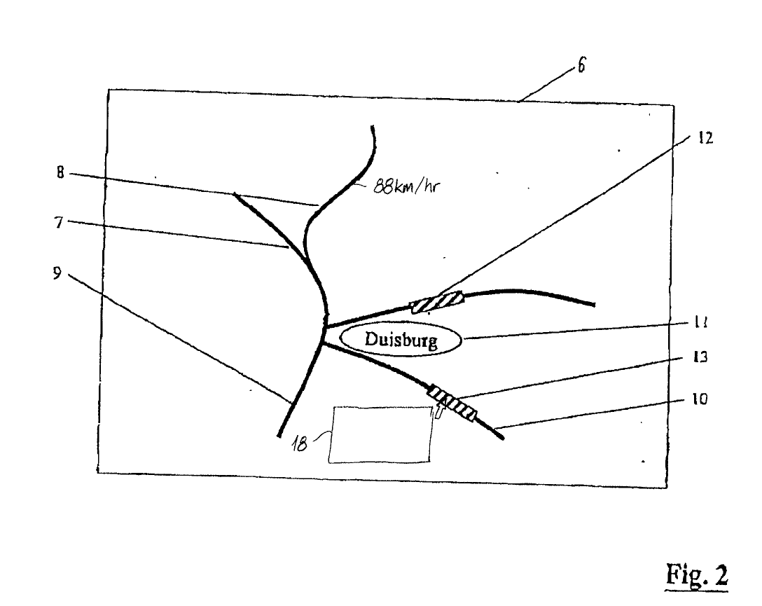

FIG. 2 shows a more detailed view of an example of the digital map 6 showing a section of a road traffic network including roads 7, 8, 9, 10, a town 11 and traffic jams 12, 13. The information 14 which here contains at least the digital map and possibly additional information (such as, e.g. text information on traffic jams on the digital map, hyperlinks, etc.) is transmitted via the networks 2, 16 (see FIG. 1). An example of additional information which may be displayed is the average speed or the traveling time of a specific section of road such as road 8 depicted in FIG. 2.

The networks 2, 16 in FIG. 1 may, for example, comprise line networks such as an ISDN D-channel. However, one or both of these networks 2, 16 may also comprise a mobile radio network. More particularly, the information 14 may be transmitted via the Internet to the modem 3 of the terminal 4 which is logged in at a service provider 15 on the Internet. The center 1 may have its own home page on the Internet. The information 14 may then be transmitted by the Internet service provider 15 to the modem 3 by line network or mobile radio. Suitable transmission protocols which may be used include, for example, http, xtp, wtp (in html, xml, wml), fttp protocols, short messages (in mobile radio), and ISDN D-channel transmission (line network).

The information 14 (e.g. the digital map 6 in FIG. 2) may be transmitted cyclically, i.e., on a periodic basis, or when the information changes. For example, the map may be transmitted when a traffic jam 12, 13 is added, changes or disappears, and when traveling times or speeds change on a route through the road traffic network 7 to 10 which is predetermined by the user of the terminal and, for example, is stored in the center 1.

In the digital map 6 in FIG. 2, a hyperlink may be deposited, for example, in the area of each of the traffic jams 12, 13. When the mouse moves over this hyperlink or when the hyperlink is clicked on, a home page is addressed in which additional information (such as traveling times, duration, cause) relating to the traffic jam such as is displayed to the user of the terminal. The additional information may be displayed in the form of a text box 18 on the display. The additional information may also be transmitted together with the information 14 containing the digital map 6 from the center 1 to the terminal 4 or from the Internet service provider 15 to the terminal 4. A mouse-over function may also be placed behind the representations of certain information, such as, for example, traffic jams 12, 13 so that when a mouse (i.e. a mouse cursor on the screen) moves over the traffic jam 12, additional information relating to this certain information (in this case to traffic jam 12) is displayed or audibly output. For each user of the terminal 4, a profile may be stored in a memory 1a in the traffic center 1 or a memory 15a in the Internet service provider 15. The profile may, for example, specify what information is to be transmitted to a user terminal and/or under what conditions it is to be transmitted to him. For example, the profile may include the section of a digital map which is to be transmitted and/or the conditions for a retransmission of the digital road map (for example new traffic jam on a particular road 8). In addition, the manner in which automatic billing is to occur is suitably specified in the terminal 4, in the traffic center 1, or at the Internet service provider 15. In particular, the payment may include a flat-rate Internet access fee. Alternatively, automatic billing for each transmission of information to be provided may also be implemented.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A method for providing information on a terminal for a user of the terminal, comprising the steps of:
(a) transmitting the information to a terminal via a channel of a telecommunication network; and
(b) displaying the information as a screensaver on a display at the terminal.

2. The method of claim 1, wherein said step (a) comprises transmitting the information to the terminal from a traffic center.

3. The method of claim 1, wherein said step of transmitting comprises transmitting the information to the terminal in response to changes on a route in a digital map contained in the information.

4. The method of claim 1, wherein said step of transmitting comprises transmitting the information cyclically.

5. The method of claim 1, wherein the information transmitted in said step (a) contains traffic information.

6. The method of claim 1, wherein the information transmitted in said step (a) contains information relating to events, points of interest, ticket offers, auctions, and specific locations.

7. The method of claim 1, wherein the information transmitted in said step (a) contains at least a portion of a digital road map.

8. The method of claim 7, wherein said step (a) comprises transmitting the at least a portion of a digital map as a bitmap.

9. The method of claim 7, wherein the at least a portion of a digital map includes markings representing at least one of a traveling time and a speed.

10. The method of claim 7, wherein the digital map includes visually emphasized markings of traffic jams.

11. The method of claim 10, wherein the at least a portion of a digital map includes hyperlinks to Internet pages are placed behind the traffic jam markings.

12. The method of claim 10, wherein the at least a portion of a digital map includes mouse-over areas on the traffic jam markings, said method further comprising the step of displaying additional information on traffic jams when the traffic jam markings on the at least a portion of the digital map are selected by one of moving a cursor over the traffic jam marking and clicking on the traffic jam marking, the additional information on traffic jams including at least one of length, intensity, duration, and cause.

13. The method of claim 7, wherein said step (a) further includes transmitting additional information to the terminal along with the information representing the digital map.

14. The method of claim 1, further comprising the step of outputting a warning to the user of the terminal in response to a change in the digital map.

15. The method of claim 1, further comprising the step of switching the screensaver on in response to a change in the route of the digital map.

16. The method of claim 1, wherein said step (a) comprises transmitting the information by Internet.

17. The method of claim 1, wherein said step (a) comprises transmitting the information by a mobile radio.

18. The method of claim 17, wherein said step (a) comprises using point-to-point short messages.

19. The method of claim 1, wherein said step (a) comprises transmitting the information via a line network.

20. The method as claimed in claim 19, wherein said step (a) comprises transmitting the information via an ISDN D-channel.

21. The method of claim 1, further comprising the step of charging a flat rate transmission costs for said step (a).

22. The method of claim 1, further comprising the step of charging individual transmission costs for each transmission of the information in said step (a).

23. The method of claim 1, further comprising the step of storing a file in the center for a user, wherein the file specifies with respect to the user of the terminal which section of a digital map is to be transmitted to him.

24. A center for providing information on a terminal for a user of the terminal, comprising:
a transmission device for transmitting information to a terminal via a channel of a telecommunication network, said information being operatively arranged for display as a screensaver on a display at the terminal.

25. The center of claim 24, further comprising a memory for receiving data specifying which information, especially which map sections of a digital map, is to be transmitted to a user of the terminal.

26. A terminal, comprising:
a receiving device for receiving information transmitted by a transmission device via a channel of a telecommunication network;
a display; and
means for displaying the information as a screensaver on the display.
